(19) United States
(12) Patent Application Publication
(10) Pub. No.: US 2008/0010068 A1
(43) Pub. Date: Jan. 10, 2008

(54) Method and apparatus for language training

(76) Inventor: Yukifusa Seita, Torrance, CA (US)

Correspondence Address: Yukifusa Seita;Beyond the Language Walls Corp., Suite 209, 3848 Carson St., Torrance, CA, 90503, US

(21) Appl. No.: 11/483,235

(22) Filed: Jul. 10, 2006

(51) Int. Cl. G10L 15/18

(52) U.S. Cl. 704/257

(57) ABSTRACT

A language training method and apparatus is provided for effectively training a native speaker's intonation and rhythm/tempo at the same time with fun. The model voice data file and trainer's voice input from a microphone may be repeatable at user's discretion through speaker, while generating and constructing a display image with contents in synchronism with the model voice derived from the image data file, a text data file, a translation data file, a model voice wave data file, a rhythm/tempo score and an intonation score. The display image may be output through a video display device and the displayed data may be derived from the text data file and the data from the translation data file may be visually modified in accordance with respective content in synchronism with the model voice.

### FIELD OF THE INVENTION

The present invention relates to a language training device and also a language training method. More specifically, it relates to a language training device or method that enables effectively acquiring the native intonation and rhythm/tempo of the subject language while maintaining the trainee's interest.

### BACKGROUND

Language training devices and methods exist that utilize a model voice. For example, the Japanese patent laid open 2002-23613 discloses a language training system displaying waveforms that are obtained from a model voice and trainee's voice. The trainee repeats his/her pronunciation so as to imitate the model voice or the result of the automated scoring system.

A similar language training device is described in the Japanese patent laid open 2003-131548 showing one example of waveform comparison in detail. Additionally, Japanese patent laid open 2002-40926 describes a test method to make a judgment more accurately and objectively by utilizing the internet. Moreover, in the Japanese patent laid open 2003-162291 a language learning system is described capable of calculating the detailed difference in intonation and indicate the points to be modified. Furthermore, Japanese patent laid open 2003-228279 describes a language learning system for improving learning efficiency by providing different types of learning programs based upon scores obtained by a predetermined learning algorithm.

Other types of language learning systems with a two translation display capability are described in Japanese patent laid open 2003-167507. Other types of English training utilizing Karaoke are described, which display text color changes in synchronism with a passage of sound reproduction then indicating a rated score in Japanese patent laid open 2004-140536.

However, there is a drawback that it is hard to the trainees to learn rhythm/tempo of the native level conversation even thought they might be able to learn the intonation and pronunciation of words since above mentioned types of language training machines just repeatedly listen to the same model voice and just talk back to a microphone.

For solving the problem, there is a language learning system that can vary the speed of the speaker. For example, Japanese patent laid open 2003-167592 describes a language leaning system for improving learning efficiency by converting the speed of the speaker higher and lower based upon the skill level. Japanese patent laid open 2004-138964 describes means for obtaining a variation of playback speed effectively. By using this means, the user can learn the rhythm/tempo in the native conversation by listening and train by speak along with the rhythm/tempo.

However, there is usually clearly audible difference between the native speaker's English and non-native speaker's English even a short sentence. This difference comes from imperfect combination of intonation and rhythm/tempo of English speech of the non- native speaker. Even the non-native speaker's intonation is all right, the rhythm/tempo is imperfect, and vise verse.

It is very important to learn accurate intonation and rhythm/tempo to let the listener understand what the speaker is saying, in English particularly. In comparison Japanese with English and other languages, for example, it has rather flat intonation and put emphasis in mid to low frequency range of voice in general. However, other languages particularly in English there is a tendency to pronounce the important words slightly long, slowly and strongly but less important words slightly short, fast and weakly as well as to put emphasis in mid to high frequency range of voice normally, so as to create a unique rhythm/tempo and intonation for each language for native speakers.

If someone fails to use correct intonation, a listener tends to interrupt the understanding of the conversation, and does not understand the contents of the conversation. The rhythm/tempo expresses the intention of the conversation, so the listener may not realize what the point is when the rhythm/tempo is disturbed.

### SUMMARY

The language training device and method according to this invention, at least a image display device and an audio processing device are included, wherein the image display device displays, in accordance with each contents in synchronism with a model voice, displaying the oscillograph of the model voice and an input trainee's voice oscillograph while text of the model voice and translation of the text with visual modification are displayed in a visual image, and displaying a score calculated by the difference between the oscillograph of the model voice and the input trainee's voice oscillographs in terms of rhyme/tempo and intonation.

Additionally, it may be desirable that the language training device and method measures multiple time periods corresponding to each portion of one breath length and obtains the measured time difference Δ_{T} between the model voice and the trainee's voice, then obtains a value Σ|Δ_{T}|/T by dividing the accumulated absolute value of difference Δ_{T} with the total time T of the model voice, obtains the Rhythm/Tempo score (M−MΣ|Δ_{T}|/T) by subtracting the value Σ|Δ_{T}|/T from a full score M, and extracts the oscillographs of one breath length of the model and trainee's voices, obtains the area Δ_{S} representing one side of the area represented by the one breath length portion, obtains the value ΣΔ_{S}/S by dividing area Δ_{S} with the total area S generated by the model voice in the ossillograph, and then subtracts the value from a full score M to obtain the intonation score (M−MΣΔ_{S}/S) .

It is one aspect of present invention that at least an image display device and an audio processing device are included, wherein the audio processing device is capable of reproducing a model voice data file and a trainee's voice inputted from one or more microphone through one or more microphone input terminals, repeatedly at user's discretion, the image display device is capable of constructing a display image corresponding to selected data in synchronism with the model voice based upon a displaying image data file, text data file for displaying the sentence, a corresponding translation data file of the text data file ready for displaying translated text in different language, a model audio waveform data file digitally processed from the model audio data file to be displayed in a form of oscillograph, a trainee's voice waveforn data file digitally processed from the trainee's voice to be displayed in a form of oscillograph, rhythm/tempo score examining the rhythm/tempo of the model voice waveform data file and the trainee's voice waveform data file, and intonation score examining the intonation of the model voice waveform data file and the trainee's voice waveform data file, wherein the video display device or video output terminal displays the display image and data from the displayed text data file and data from the corresponding translation data file are visually modified in synchronism with the model voice.

Further, it may be desirable to play back the BGM (Back Ground Music) continuously or intermittently from the device according to the present invention. Moreover, it may be desirable to conduct voice recognition to the trainee's voice and add the degree of recognition to the score. Furthermore, it may be desirable to constitute the model data file, the text data file and the corresponding translation data file to be dividable in one breath unit or one sentence unit, and the training may be conducted in the one breath unit or one sentence unit at trainee's discretion repeatedly. Moreover, the pitch of the reproduced audio may be maintained in substantially the same level while the playback speed of from the model voice data file may be changed faster or slower.

It may be desirable to construct the device to record the audio and video outputs, which may be played back if needed. Additionally, either the model voice and/or the trainee's voice outputs may be modified to have some reverb (add diminished and delayed audio signal). Further, the pitch of the model voice may be modifiable to any desired pitch. Moreover, the output audio may be amplified so as to equalize the certain frequency band to a desired sound level.

The model voice data file, the image data file, the text data file, and the corresponding translation data file may be provided with an internal memory device or supplied in a removable recording media together with its playback device. It is another aspect of the present invention that at least an image display device and an audio processing device may be included, wherein the audio processing device may be capable of reproducing an educational audio in an external educational material and a trainee's voice inputted from one or more microphone through one or more microphone input terminals, repeatedly at user's discretion. The image display device may be capable of constructing a display image corresponding to an educational video in the external educational material, a model audio waveform data file digitally processed from the educational audio to be displayed in a form of an oscillograph, a trainee's voice waveform data file digitally processed from the trainee's voice to be displayed in a form of an oscillograph, a rhythm/tempo score examining the rhythm/tempo of the model voice waveform data file and the trainee's voice waveform data file, and an intonation score examining the intonation of the model voice waveform data file and the trainee's voice waveform data file, wherein the video display device or video output terminal displays the display image in synchronism with the educational audio.

It is another aspect of this invention that the language training method may provide at least a image display device and an audio processing device, reproduce an educational audio in an educational material by using the audio processing device, produce a trainee's voice inputted from one or more microphone through one or more microphone input terminals repeatedly at user's discretion, examine the rhythm/tempo of the model voice waveform data file and the trainee's voice waveform data file and create a rhythm/tempo score and also examines the intonation of the model voice waveform data file and the trainee's voice waveform data file and creating a intonation score, construct a display image corresponding to the educational material, a model audio waveform data file digitally processed from the educational audio to be displayed in a form of oscillograph, a trainee's voice waveform data file digitally processed from the trainee's voice to be displayed in a form of oscillograph, the rhythm/tempo score, and the intonation score, and output the display image in synchronism with the educational audio to a image display.

Additionally, it is desirable to make the display position within the display image of the oscillograph digitally processed from the trainee's voice and the oscillograph digitally processed from the educational audio movable as desired or as selected. It is also desirable to have a unit that controls a playback device of a tape or a disk containing the external educational material, capable of storing the educational audio and the educational video for repeatability playing back the educational contents for certain period of time based upon a repeat and stop operation, and the playback device stops playing or put a pause temporarily.

It is preferable that the external educational material is provided with an internal memory device or supplied in a removable recording media together with its playback device. Moreover, it is desirable to include at least one unit out of a group consisting of a screen, screen driver, speaker and earphone output terminal.

By indicating with visual modifications the text corresponding to the model voice and its translation in synchronized with each content of the model voice, all of voice conversation training, listing practice and grammatical review can be achieved at the same time. Further more, the improvement of the trainee's skill level is clearly understood by indicating the oscillographs of the model voice and the input trainee's voice, and by indicating a score by obtaining the difference between in rhythm/tempo and intonation from the oscillograph of the model voice and the input trainee's voice. Moreover, it is completely understood the perfect intonation and rhythm/tempo by utilizing three different speeds, by selectively playing back slower, normal and faster.

### BRIEF DESCRIPTION OF THE DRAWINGS

FIG. 1 shows the construction diagram of the language training device according to the present invention.

FIG. 2 shows the construction diagram of the external educational equipment.

FIG. 3 shows the internal block diagram of the language learning device of one embodiment of the present invention.

FIG. 4 shows a flowchart of a language learning device.

FIG. 5 shows a flowchart of a language learning device.

FIG. 6 shows a flowchart of a language learning device.

FIG. 7 shows an embodiment of a construction of a displayed image.

FIG. 8 shows an embodiment of a construction of a displayed image.

FIG. 9 shows an embodiment of a displayed image.

FIG. 10 shows an embodiment of a displayed image.

FIG. 11 shows an embodiment of a displayed image.

The use of the same symbols in different drawings typically indicates similar or identical items.

### DETAILED DESCRIPTION

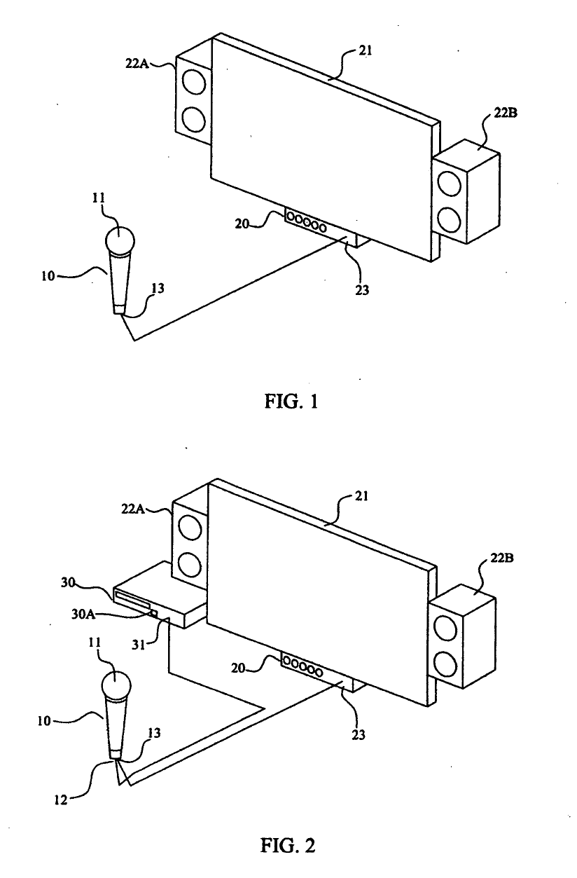

FIG. 1 shows the construction diagram of the language training device according to the present invention. The language training device 10 has a microphone 11, input and output terminals 13, detachable memory and connector, controller switches, battery power supply unit and so on. It is desirable to make the microphone easy to hold and add a self supporting stand the same way as a regular microphone. The controller switches can be push buttons or some pointer device utilized in notebook computers or mobile phones.

Output terminal 13 is connected to an input terminal 23 of the screen driver 20. And the screen driver 22, screen 21, speaker 22a and 22b are mutually connected according to the specifications of the equipment. A regular home video projector, a TV receiver, or professional Karaoke equipment can be used for the screen driver 22, a screen 21, speaker 22a and 22b.

FIG. 2 shows the construction diagram of the external educational equipment. In addition to the components shown in FIG. 1, an output terminal 31 of a tape/disk player 30 is connected with the input terminal 12 of the language training device 10. Further, it is also possible to have an infrared signal transmission device in the language training device when the tape/disk player 30 comes with an infrared receiver. The tape/disk player 30 can be existing equipment for learning materials, a video cassette recorder, a CD player, or a DVD player. The infrared data transmission protocol is publicly available and the infrared command can be memorized from the attached remote control hand unit, so that an infrared command generating program is built in the tape/disk player 30.

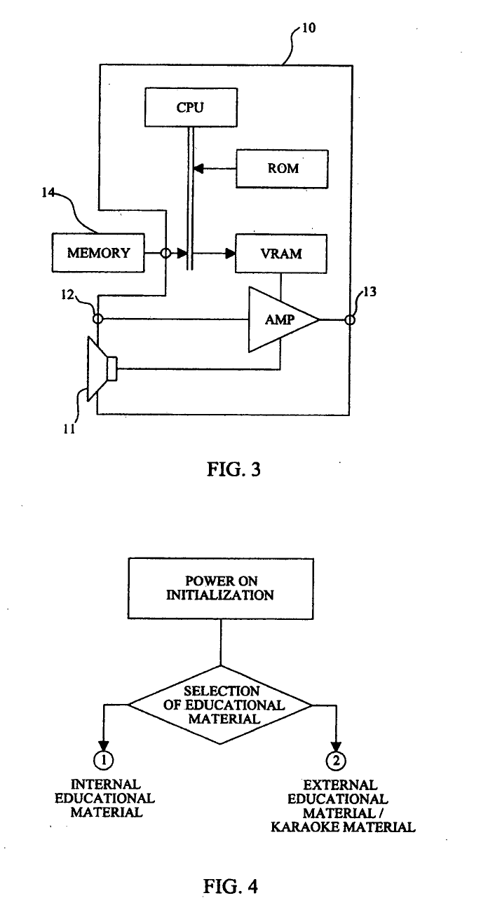

FIG. 3 shows the internal block diagram of the language training device of one embodiment of the present invention. The language training device according to the invention includes a microprocessor and its peripheral devices. In this embodiment, any of these components can be non-specialized products. For example, the power source can be an external power transformer but preferably include a dry battery or rechargeable battery.

A detachable memory 14 contains a model voice data file, an image data file, a test data file that can express some sentences, and a corresponding translation data file that can express the sentences in a different language. ROM (Read Only Memory) includes program files that are capable of executing processes described below.

The model voice data file, the image data file, the text data file and the corresponding translation data file can be provided with in a built-in memory device such as a flash memory or a hard disk drive, alternatively supplied in a form of any removable recording media such as MD (Mini Disc: A trademark of Sony Corporation) or DVD (Digital Versatile Disc: A trademark of DVD Forum) together with its built-in playback unit.

The model voice data file is converted to an audio signal then supplied to an output terminal 13 together with trainee's voice input from either one or more microphone 11 and one or more input terminal (not shown but can be generic ones) appropriately and in repeatable way. It should be born in mind it is also possible to add speaker to the output terminal 13. Accordingly, both software and hardware processing the conversion of audio signals to and from digital and analog status are built in this language training device.

In the audio signal processing flow, it further can superimpose a BGM (Back Ground Music) continuously or intermittently. The BGM signal can be supplied from audio equipment connected the above mentioned input terminals or a memory device contains music data. Furthermore, based upon user's selection of the setting, one of normal, slower and faster playback speed or pitch can be output for the model voice obtained from the model voice data file. The selection of the setting can be made by pushing switch buttons observing the selection choices displayed on the screen 21. The slower speed makes the model voice easier to understand its meaning together with minute pronunciation details that is otherwise never understood. On the contrary, the faster speed makes it easier to understand and train the total rhythm/tempo.

It can be made within a scope of this invention to include software and hardware capable of adding reverb or echo effect to either or both of model voice and trainee's voice. In some phone systems (such as IP phones), it sometimes has a feedback echo of the person on the line with some delay. It is therefore desirable to set up the strength (volume) and duration (delay) by utilizing known audio processing technology. Accordingly, this mode of operation makes the trainee easier to listen to the trainee's voice and the model voice.

In case that the speaker of the model voice and the trainee are in opposite sex, or the difference in pitches (an average frequency of the principal voice) of theirs large, adjustment of pitch of the model voice is available by utilizing known digital processing technology. The setting is possible by operating switches by observing the selection from the screen 21 or just adjusts according to the preference of the user. In the same way, the trainee's voice pitch can be modified to a desired level according to known digital processing also.

The device also contains the equalizer function so as to output the sound output in a desired frequency characteristics by modifying the sound signal level of the certain frequency bandwidth. The equalizer function is obtainable by choosing out of known technologies. It turned to be a good training by emphasizing the mid to high pitch tone by utilizing the equalizer for typical foreign languages (such as English) that have stresses on consonant. The better improvement of the listening comprehension is expected by utilizing the equalized voice training. Furthermore, when the trainee's native languages (such as Japanese) have a tendency to emphasize the mid to low pitch tone, the difference between the trainee's intonation and rhythm/tempo become easier to understand by emphasizing the mid to high pitch tone. It is also desirable to put emphasis on mid to high frequency components even BGM only, since sensitivity to the frequency range becomes higher so that the listening comprehension skill also improves.

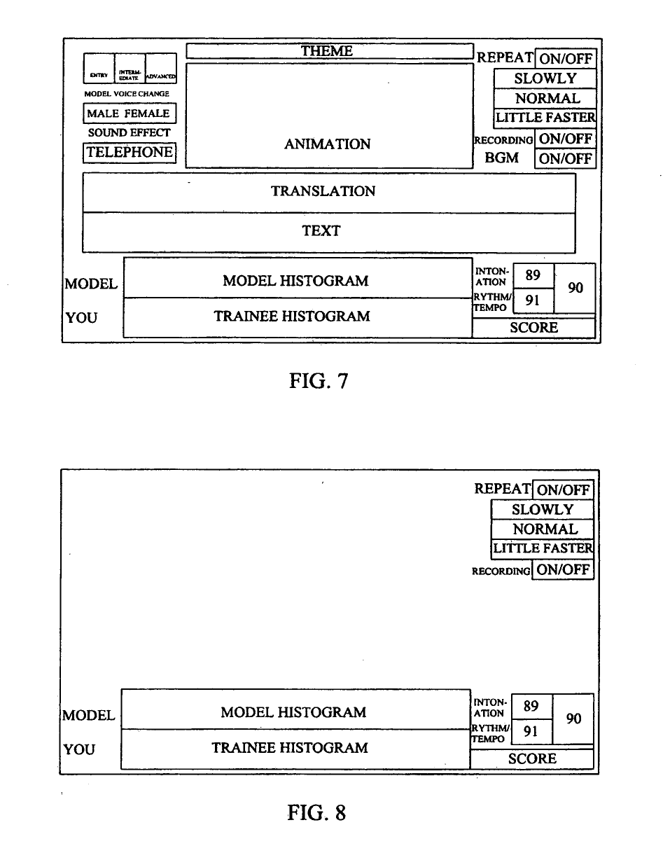

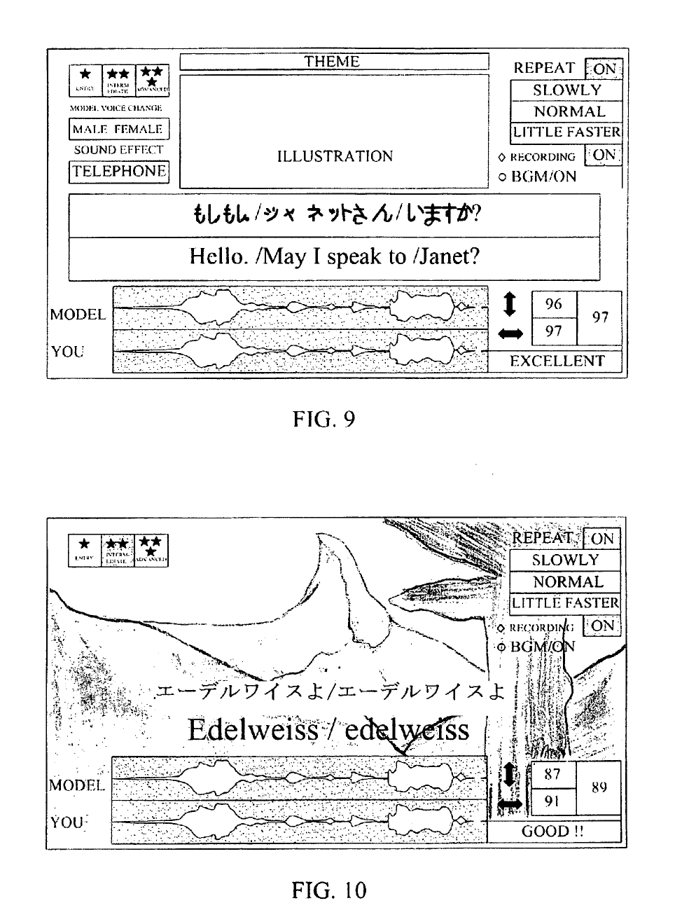

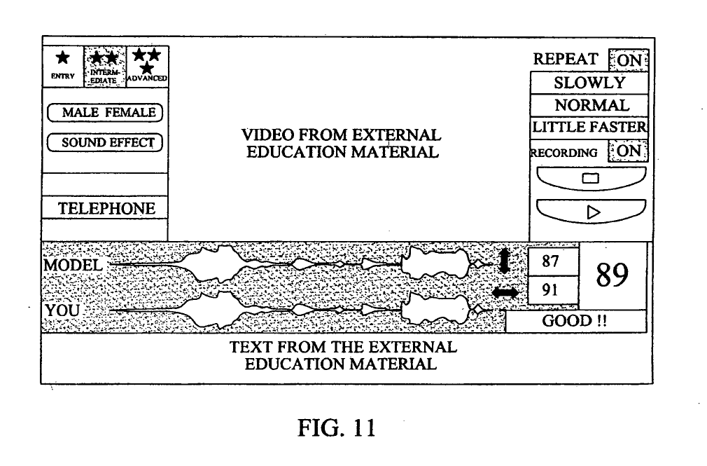

Embodiments of displayed image can be seen on FIG. 7 and FIG. 9. In these figures, the displayed image is constructed with a display image corresponding to selected data in synchronism with the model voice based upon a displaying image data file, text data file, a corresponding translation data file, a model audio waveform data file digitally processed from the model audio data file to be displayed in a form of oscillograph, a trainee's voice waveform data file digitally processed from the trainee's voice to be displayed in a form of oscillograph, a rhythm/tempo score examining the rhythm/tempo of the model voice waveform data file and the trainee's voice waveform data file, and an intonation score examining the intonation of the model voice waveform data file and the trainee's voice waveform data file. Each of these elements is represented Animation, Text, Translation, Model Oscillograph, Trainee Oscillograph, Rhythm/Tempo, and Intonation icons respectively.

The scoring of rhythm/tempo is based upon the measurement of multiple of time periods corresponding to each portion of one breath length and obtains the measured time difference Δ_{T} between the model voice and the trainee's voice, then obtains a value Σ|Δ_{T}|/T by dividing the accumulated absolute value of difference Δ_{T} with the total time T of the model voice, obtains the Rhythm/Tempo score (M−MΣ|Δ_{T}|/T) by subtracting the value from a full score M. Accordingly, the highest score is 100 given M=100 and there is no subtraction. By changing the value M, adjustment can be made for the full score and the easily available score.

The scoring of intonation is obtained by extracting the oscillographs of one breath length of the model and trainee's voices, obtaining the area Δ_{S} representing one side of the area represented by the one breath length portion, obtaining the value ΣΔ_{S}/S by dividing area Δ_{S} with the total area S generated by the model voice in the ossillograph, then subtracting the value from a full score M to obtain the intonation score (M−MΣΔ_{S}/S) . Accordingly, the highest score is 100 given M=100 and there is no subtraction. By changing the value M, adjustment can be made for the full score and the easily available score. This feature is particularly important because of the following reason. In case the single scoring method is provided the higher skilled group of trainees gets higher score. However, when entry level person gets the score measured in the same way as the higher skilled trainees, it is lower.

In the language training, it sometimes may demotivate the trainee to continue his/her training. It is therefore useful to give the trainee some additional score for example to add 20 points. Then raw score may be 20 but indicated score will be come 40. This adjustment is very useful until the trainee gets up to 60 points raw score. It is very important to motivate the trainee to continue using the language training device.

Accordingly, the improvement in trainee's language skill is clearly and visually understood with interest by displaying the oscillographs of the model voice and the trainee's voice as well as the scores calculated from the difference in rhythm/tempo and intonation from the oscillographs of the model voice and the trainee's voice, so that the trainee can acquire the native level intonation and rhythm/tempo at once efficiently.

Furthermore, the text and its translation are visually modified according to the model voice and synchronized contents in a same way as video karaoke does on its lyric. Since the word order varies in each language and the visual modification takes place in both original text and its respective translation at the same time, it effectively helps the trainee review the grammar of the language to learn. The visual modification can be the color change as well known in karaoke, changes in contrast, or size of the characters. As a result, conversational training, listening training and grammatical review can be done at once.

It should be noted that indication of the skill level (such as entry, intermediate, or advanced levels), switchable various setting information, or result of the training (“Not Good!!”, “Good!!”, “Excellent!!”) may be also included on the display image.

It is most desirable to use a rhythm/tempo score and an intonation score by utilizing a method to process the oscillograph with certain evaluation function for obtaining numerical value. Further, the average score of the trainings or trainees can be indicated large portion of the screen and the result of voice recognition result of the trainee's voice can be added to the scoring system.

Moreover, the device can be modified to include a recording mechanism to record and playback the audio and video outputs at random with known digital signal compression device and system for recording the compressed file to a memory 14.

By utilizing this type of voice training device, its user can enjoy the language training like karaoke and even can compete with each other for a higher score among family members or friends together. It is a breakthrough of the language training that tends to make the trainees' pronounciations go from being like indistinct mutterings to more natural voice levels. It should be born in mind that the meaning of language training should be understood to have a broader meaning than the normal dictionary definition, to include any voice training that requires adequate intonation and rhythm/tempo.

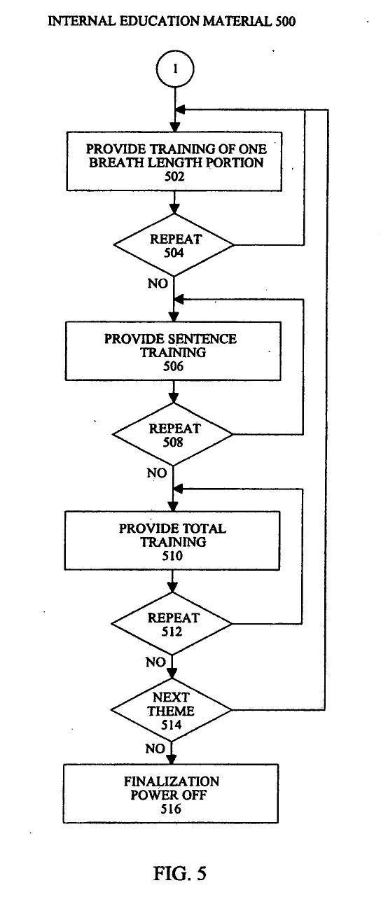

A program incorporated in the preferred embodiment of this invention will be explained with the attached flowcharts FIGS. 4 through 6. FIG. 4 shows the process after turning the power switch on to be an initialization stage to accept the selection of either internal or external training materials by a selection switch. When the internal training material is selected, the program runs according to the flowchart on FIG. 5. Examples of the displayed screen images are shown on FIG. 7 through 9.

First, one breath length portion of the training material is repeated as desired, then a sentence training is repeated as the trainee wishes, and lastly the entire training material is repeated as desired followed by a new training theme. Obviously, the model voice data file, the text data file and the corresponding data file are divided in one breath length. The repetition of the training can be executed by the selection of the trainee suggested by the program with voice or visual inquire, for predetermined number indicated on the screen, or only after the resultant score reached or exceed a predetermined score level.

Furthermore, by utilizing three playback speeds, first learn the meaning of the sentence and basic pronunciation with slow speed, then learn the intonation and rhythm/tempo of normal native speech with normal speed, and finally learn the intonation and rhythm/tempo of relatively fast native speech as a whole with fast speed. The built-in software or program may be modified to incorporate this unique training feature.

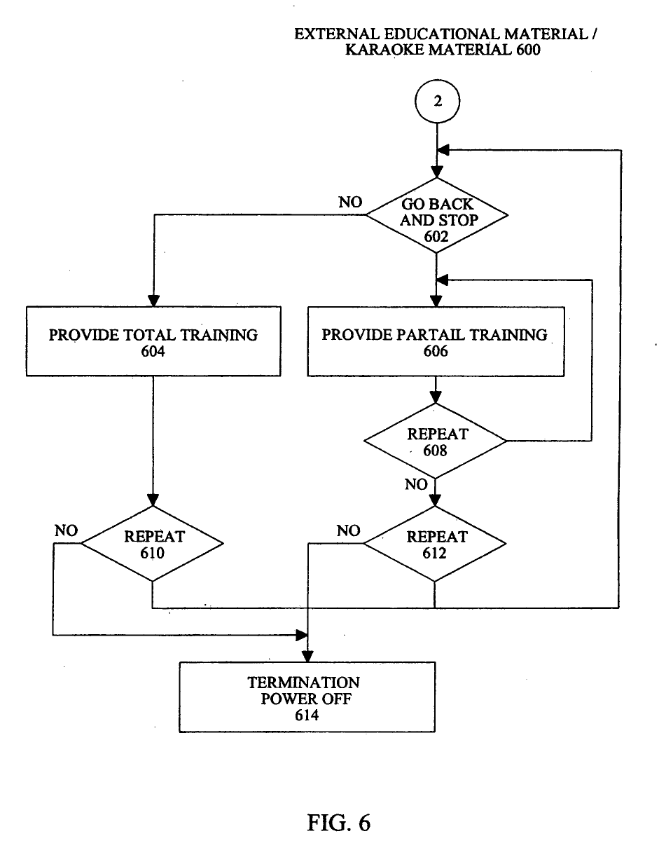

When the external training material is selected, the program runs according to the flowchart on FIG. 6 and the examples of the displayed screen images are shown on FIG. 8, 10 and 11. The contents of the external training material can be karaoke or music video, which is not necessarily a language training material.

Until the trainee chooses to initiate go-back and stop operation by pushing a built-in go-back and stop switch (it can be a separate switch or some key on a keyboard), the external training material may continuously be playing. When the go-back and stop switch is pushed, the playing point in time goes back a certain amount of time, then the trainee can train with the same portion repeatedly as desired. The a hard disk drive or a flash memory is installed in the language training device so as to be able to accumulate the educational audio and video materials while the player of the external educational material put on pause or hold for playing according such signal through the infrared transmission device.

Since the external educational material may contain some text, the display positions can be selectable and movable on the display screen for an oscillograph obtained from the trainee's voice through digital processing, and an oscillograph obtained from the voice of educational material.

All of the blocks in the flowcharts can be implemented by a software built-in the language training device. Those processes will become readily apparent to those skilled in the art, and all such design or modifications are deemed within the spirit and scope of the present invention, only as limited by the appended claims.

What is claimed is:

1. A language learning apparatus comprising:
an image display device; and
an audio processing device,
wherein the image display device displays, in accordance with each contents in synchronism with a model voice, the oscillograph of the model voice, and an input trainee's voice oscillograph, while text of the model voice and a translation of the text of the model voice with a visual modification are displayed in a visual image, and displays a score calculated by the difference between the oscillograph of the model voice and the input trainee's voice oscillographs in terms of rhyme/tempo and intonation.

2. The language learning apparatus as claimed in claim 1, wherein the apparatus measures multiple time periods corresponding to each portion of one breath length and obtains the measured time difference Δ_{T} between the model voice and the trainee's voice, then obtains a value Σ|Δ_{T} by dividing an accumulated absolute value of difference Δ_{T} with a total time T of the model voice, obtains a rhythm/tempo score (M−MΣ|Δ_{T}|/T) by subtracting the value Σ|Δ_{T}|/T from a full score M, and extracts an oscillograph of one breath length of the model and trainee's voices, obtains an area Δ_{S} representing one side of an area represented by the one breath length portion, obtains a value ΣΔ_{S}/S by dividing the area Δ_{S} with a total area S generated by the model voice in the ossillograph, and subtracta the value from a full score M to obtain the intonation score (M−MΣΔ_{S}/S)

3. The language learning apparatus as claimed in claim 1, wherein a display position within the display image of the oscillograph is digitally processed from the trainee's voice and the oscillograph is digitally processed from an educational audio movable as desired or as selected.

4. The language learning apparatus as claimed claims I further including a unit that controls a playback device of a tape or a disk containing external educational material, capable of storing an educational audio and an educational video for repeatably playing back the educational contents for a certain period of time based upon a repeat and stop operation, and the playback device stops playing pauses temporarily.

5. The language learning apparatus as claimed in claim 1, wherein an external educational material is provided with an internal memory device or supplied in a removable recording media together with its playback device.

6. A language learning apparatus comprising:
an image display device; and
an audio processing device, wherein the audio processing device is capable of reproducing a model voice data file and a trainee's voice inputted from one or more microphones through one or more microphone input terminals, repeatedly at a user's discretion, the image display device is capable of constructing a display image corresponding to selected data in synchronism with a model voice based upon displaying an image data file, text data file for displaying the sentence, a corresponding translation data file of the text data file ready for displaying translated text in different language, a model audio waveform data file digitally processed from the model audio data file to be displayed in a form of oscillograph, a trainee's voice waveform data file digitally processed from the trainee's voice to be displayed in a form of an oscillograph, a rhythm/tempo score examining the rhythm/tempo of the model voice waveform data file and the trainee's voice waveform data file, and an intonation score for examining the intonation of the model voice waveform data file and the trainee's voice waveform data file, wherein the video display device or video output terminal displays the display image and data from the displayed text data file and data from the corresponding translation data file are visually modified in synchronism with the model voice.

7. The language learning apparatus as claimed in claim 6, wherein a BGM (Back Ground Music) can be played back continuously or intermittently.

8. The language learning apparatus as claimed in claim 6, wherein the apparatus is configured to conduct voice recognition to the trainee's voice and add the degree of recognition to the score.

9. The language learning apparatus as claimed in claim 6, wherein the apparatus includes the model data file, the text data file and the corresponding translation data file dividable in one breath unit or one sentence unit, and the training can be conducted in the one breath unit or one sentence unit at a trainee's discretion repeatedly.

10. The language learning apparatus as claimed in claim 6, wherein the apparatus is configured so that the pitch of the reproduced audio is maintained in substantially the same level while the playback speed from the model voice data file can be changed faster or slower.

11. The language learning apparatus as claimed in claim 6, wherein the apparatus is configured to record the audio and video outputs and can be played back as needed.

12. The language learning apparatus as claimed in claim 6 wherein, either the model voice and/or the trainee's voice outputs can be modified to have some reverb.

13. The language learning apparatus as claimed in claim 6, wherein the pitch of the model voice can be modifiable to any desired pitch.

14. A language learning apparatus as claimed claim 6 wherein the pitch of the trainee's voice can be modifiable to any desired pitch.

15. The language learning apparatus as claimed claim 6, wherein the output audio can be amplified so as to equalize a certain frequency band to a desired sound level.

16. The language learning apparatus as claimed claim 6, wherein the apparatus is configured so that he model voice data file, the image data file, the text data file, and the corresponding translation data file are provided with an internal memory device or supplied in a removable recording media together with its playback device.

17. A language training method comprising, providing at least an image display device and an audio processing device;
reproducing an educational audio in an educational material by using the audio processing device;
producing a trainee's voice inputted from one or more microphone through one or more microphone input terminals, repeatedly at a user's discretion;
examining a rhythm/tempo of a model voice waveform data file and a trainee's voice waveform data file and creating a rhythm/tempo score, and also examining an intonation of the model voice waveform data file and the trainee's voice waveform data file and creating an intonation score;
constructing a display image corresponding to the educational material, a model audio waveform data file digitally processed from the educational audio to be displayed in a form of oscillograph, a trainee's voice waveform data file digitally processed from the trainee's voice to be displayed in a form of oscillograph, the rhythm/tempo score, and the intonation score; and
outputting the display image in synchronism with the educational audio to an image display.

18. The language training method as claimed in claim 17, wherein the step of examining further comprises:
measuring multiple of time periods corresponding to each portion of one breath length;
obtaining the measured time difference Δ_{T} between the model voice and the trainee's voice; and
obtaining a value Σ|Δ_{T}|/T by dividing the accumulated absolute value of difference Δ_{T} with the total time T of the model voice, and obtaining the rhythm/tempo score (M−MΣ|Δ_{T}|/ T) by subtracting the value Σ|Δ_{T}|/T from a full score M, extracting the oscillographs of one breath length of the model and trainee's voices, obtaining the area Δ_{S} representing one side of the area represented by the one breath length portion, obtaining the value ΣΔ_{S}/S by dividing area Δ_{S} with the total area S generated by the model voice in the ossillograph, and subtracting the value from a full score M to obtain the intonation score (M−MΣΔ_{S}/S)

19. The language training method as claimed in claim 17, further comprising:
modifying a pitch or a speed of the educational audio according to a selection of a trainee.

20. The language training method as claimed in claim 18, further comprising:
conducting voice recognition to the trainee's voice and adding a degree of recognition to the score to be indicated in the display image.
